(19) United States
(12) Patent Application Publication
(10) Pub. No.: US 2023/0390947 A1
(43) Pub. Date: Dec. 7, 2023

(54) AUTOMATED GRIPPING MECHANISM

(71) Applicant: GEN-PROBE INCORPORATED, San Diego, CA (US)

(72) Inventors: Rolf SILBERT, Del Mar, CA (US); HongRan PENG, San Diego, CA (US)

(21) Appl. No.: 18/249,540

(22) PCT Filed: Oct. 21, 2021
(86) PCT No.: PCT/US2021/056000

§ 371 Date: Apr. 18, 2023

Related U.S. Application Data
(60) Provisional application No. 63/104,401, filed on Oct. 22, 2020.

(51) Int. Cl. B25J 15/08

(52) U.S. Cl. CPC B25J 15/08

(57) ABSTRACT

A container gripping mechanism includes first and second linear rails disposed on opposed sides of a linear rail mount. A first linear rail guide coupled with the first rail is supported on a first gripper finger mount, and a second linear rail guide coupled with the second rail is supported on a second gripper finger mount. A first gripper finger is secured to the first gripper finger mount, and a second gripper finger is secured to the second gripper finger mount. A pinion gear driven by a drive motor engages racks attached to the first and second gripper finger mounts, such that rotation of the pinion in a first direction causes the first and second gripper fingers to move toward each other, and rotation of the pinion in a second direction causes the first and second gripper fingers to move away from each other.

### FIELD OF THE DISCLOSURE

This disclosure relates to a gripping mechanism for gripping a container, such as a cylindrically-shaped container having a vertical orientation (e.g., test tube).

### BACKGROUND

In automated systems that process liquids, slender, elongated liquid containers, such as test tubes, may be supported in an upright, or vertical, orientation, for example, in a rack configured to hold one or more of such containers or on a conveyor configured to transport the containers between locations within the system. Frequently, the structures supporting such containers envelop a lower portion of each container (e.g., the lower 25-50% of each container) so that an upper portion of each container extends above the supporting structure without having any contact with an adjacent container or structure.

It is frequently necessary to grasp individual containers that are supported in such an upright orientation so that the container can be removed from the structure supporting it, transferred to another location within the system, and then placed in another structure in which the container will again be supported in an upright orientation. In general, the container can be grasped, or gripped, by contacting the container on opposite sides with gripping elements and applying equal and opposite gripping force to squeeze the container between the gripping elements. Often, such containers are supported in spatially congested conditions, with one or more other containers and/or other system structures located in close proximity to each container. In such congested conditions, especially where a top portion of each container extends above the supporting structure, it is often most practical to approach the container to be grasped with the gripping elements from above the container with the gripping elements spread far enough apart to permit the gripping elements to be lowered from positions above the container to positions at which the gripping elements are adjacent to opposed sides of the container. At the same time, the gripping elements cannot be spread so far apart that they will contact other containers or structure in close proximity to the container to be grasped as the gripping elements are lowered.

After the gripping elements have been lowered to positions adjacent to opposed sides of the container, the gripping elements must be moved together toward one another to apply equal and opposite gripping force to the sides of the container. Similarly, after the container has been moved to a new location within the system, the gripping elements must release the container by moving apart from one another and must do so without contacting adjacent containers and/or other structures in close proximity to the released container. Due to the limited amount of available space adjacent to each of the containers, the mechanisms that actuate the gripping elements to move them together to grip the container or apart to release the container are themselves most practically located vertically above the container.

Thus, a need exists for a gripping mechanism that is able to grasp elongated containers that are supported in upright orientations and in close proximity to one another and/or other structures.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof its sole purpose is to present some concepts in a simplified form as a prelude to the more detailed description that is presented later.

Examples described herein include a mechanism for gripping a container. The mechanism may include a linear rail mount having first and second, laterally-opposed sides. First and second linear rails may be disposed on, respectively, the first and second sides of the linear rail mount. The mechanism may include a first gripper finger mount including a first mounting flange disposed below the linear rail mount. A first linear rail guide may be supported on the first gripper finger mount and coupled with the first linear rail on the first side of the linear rail mount. A first rack may be supported on the first gripper finger mount. The mechanism may include a second gripper finger mount including a second mounting flange disposed below the linear rail mount. A second linear rail guide may be supported on the second gripper finger mount and coupled with the second linear rail on the second side of the linear rail mount. A second rack may be supported on the second gripper finger mount. A first gripper finger may be secured to the first mounting flange of the first gripper finger mount and extend below the linear rail mount, and a second gripper finger may be secured to the second mounting flange of the second gripper finger mount and extend below the linear rail mount. The mechanism may include a drive motor and a pinion gear coupled to the drive motor and engaged with the first and second racks such that rotation of the pinion gear by the drive motor in a first direction causes the first and second gripper fingers to move toward each other and rotation of the pinion gear by the drive motor in a second direction causes the first and second gripper fingers to move away from each other.

In some examples, the first linear rail guide of the first gripper finger mount may include a rail slot that receives the first linear rail, and the second linear rail guide of the second gripper finger mount may include a rail slot that receives the second linear rail.

In some examples, the first and second linear rails may be attached to, respectively, the first and second sides of the linear rail mount by mechanical fasteners.

In some examples, the first gripper finger mount may include a vertical wall disposed adjacent the first side of the linear rail mount, and the first mounting flange of the first gripper finger mount may extend laterally from a bottom end of the vertical wall of the first gripper finger mount beyond the second side of the linear rail mount. The second gripper finger mount may include a vertical wall disposed adjacent the second side of the linear rail mount, and the second mounting flange of the second gripper finger mount may extend laterally from a bottom end of the vertical wall of the second gripper finger mount beyond the first side of the linear rail mount.

In some examples, the first linear rail guide of the first gripper finger mount may be secured within a slot formed in the vertical wall of the first gripper finger mount, and the second linear rail guide of the second gripper finger mount may be secured within a slot formed in the vertical wall of the second gripper finger mount.

In some examples, the mounting flange of each of the first and second gripper finger mounts may have a step formed in an edge of the mounting flange facing the mounting flange of the other of the first and second gripper finger mounts.

In some examples, the first rack may be fastened to a top edge of the vertical wall of the first gripper finger mount, and the second rack may be fastened to a top edge of the vertical wall of the second gripper finger mount.

In some examples, the first rack may be fastened to the first gripper finger mount, and the second rack may be fastened to the second gripper finger mount.

In some examples, the first gripper finger comprises a first mounting base connected to the first mounting flange of the first gripper finger mount, and the second gripper finger comprises a second mounting base connected to the second mounting flange of the second gripper finger mount.

In some examples, the mounting base of each of the first and second gripper fingers may have a step formed in an edge of the mounting base facing the mounting base of the other of the first and second gripper fingers.

In some examples, the first gripper finger may include an upper vertical segment, a lower vertical segment, an angled segment between a lower end of the upper vertical segment and an upper end of the lower vertical segment so that the lower vertical segment is laterally offset to a position closer to the second gripper finger than the upper vertical segment, and a gripper segment that is laterally offset from the lower vertical segment so as to be disposed closer to the second gripper finger than the lower vertical segment of the first gripper finger. The second gripper finger may include an upper vertical segment, a lower vertical segment, an angled segment between a lower end of the upper vertical segment and an upper end of the lower vertical segment so that the lower vertical segment is laterally offset to a position closer to the first gripper finger than the upper vertical segment, and a gripper segment that is laterally offset from the lower vertical segment so as to be disposed closer to the first gripper finger than the lower vertical segment of the second gripper finger.

In some examples, the upper vertical segments, the lower vertical segments, and the angled segments may be formed of spaced-apart bars.

In some examples, the gripper segment of each of the first and second gripping fingers may include converging, angled gripping surfaces.

In some examples, the mechanism may include an elastomeric gripping pad secured to the angled gripping surfaces of each of the first and second gripping fingers.

In some examples, the elastomeric gripping pad may be formed from a fluoropolymer elastomer and synthetic rubber compound.

In some examples, the rack of the first gripper finger mount is positioned outwardly from the first side of the linear rail mount and above a top edge of the linear rail mount, and the rack of the second gripper finger mount is positioned outwardly from the second side of the linear rail mount and above a top edge of the linear rail mount.

In some examples, the first and second gripping fingers may be configured to grasp a container in an upright orientation from a position above the container.

In some examples, the container may include a test tube.

Examples disclosed herein include a mechanism for gripping a container. The mechanism may include a linear rail mount having first and second, laterally opposed sides and first and second linear rails disposed on, respectively, the first and second sides of the linear rail mount. The mechanism may include a first gripper finger assembly that includes a first gripper finger and a first gripper finger mount, and the first gripper finger mount may include a first linear rail guide coupled with the first linear rail on the first side of the linear rail mount and a first mounting flange disposed below the linear rail mount to which the first gripper finger is attached. The mechanism may include a second gripper finger assembly that includes a second gripper finger and a second gripper finger mount, and the second finger gripper mount may include a second linear rail guide coupled with the second linear rail on the second side of the linear rail mount and second a mounting flange disposed below the linear rail mount to which the second gripper finger is attached. The first and second gripper finger assemblies may be configured to be movable with respect to each other so as to move the first and second gripper fingers toward or away from each other. The mechanism may additionally or alternatively include a drive motor coupled to the first and second gripper finger assemblies such that rotation of the drive motor in a first direction causes the first and second gripper fingers to move toward each other and rotation of the drive motor in a second direction causes the first and second gripper fingers to move away from each other. In some examples, the first gripper finger may include an upper vertical segment, a lower vertical segment, an angled segment between a lower end of the upper vertical segment and an upper end of the lower vertical segment so that the lower vertical segment is laterally offset to a position closer to the second gripper finger than the upper vertical segment, and a gripper segment that is laterally offset from the lower vertical segment so as to be disposed closer to the second gripper finger than the lower vertical segment of the first gripper finger. In some examples, the second gripper finger may include an upper vertical segment, a lower vertical segment, an angled segment between a lower end of the upper vertical segment and an upper end of the lower vertical segment so that the lower vertical segment is laterally offset to a position closer to the first gripper finger than the upper vertical segment, and a gripper segment that is laterally offset from the lower vertical segment so as to be disposed closer to the first gripper finger than the lower vertical segment of the second gripper finger.

In some examples, the first gripper finger assembly may include a first rack, and the second gripper finger assembly may include a second rack.

In some examples, the mechanism may additionally or alternatively include a pinion gear coupled to the drive motor and operatively engaged with the first and second racks.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIG. 1 is a perspective view of an automated gripping mechanism as disclosed herein.

FIG. 2 is a partial end view of the gripping mechanism.

FIG. 3 is an exploded perspective view of a linear rail mount, a first linear rail, a first linear rail guide, and a first gripper finger mount.

FIG. 4 is an exploded perspective view of the linear rail mount and the first gripper finger mount.

FIG. 5 is an exploded perspective view of the linear rail mount and a second linear rail of the gripping mechanism.

FIG. 6 is an exploded perspective view of the first gripper finger mount and the first linear rail guide.

FIG. 7 is a perspective view of the first gripper finger mount.

FIG. 8 is a perspective view of the second linear rail.

FIG. 9 is a top perspective view of the first linear rail guide.

FIG. 10 is a bottom perspective view of the first linear rail guide.

FIG. 11 is an exploded, bottom perspective view of first and second gripper fingers and first and second gripper finger mounts of the robotic gripping mechanism.

FIG. 12 is a top perspective view of the first and second gripper fingers.

FIG. 13 is a first perspective view of the first gripper finger.

FIG. 14 is a second perspective view of the first gripper finger.

FIG. 15 is a side elevation view of the first gripper finger and a capped container.

FIG. 16 is a front elevation view of the first gripper finger.

FIG. 17 is a rear elevation view of the first gripper finger.

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

Unless defined otherwise, all terms of art, notations and other technical terms or terminology used herein have the same meaning as is commonly understood by one of ordinary skill in the art to which this disclosure belongs. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

This description may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left of, right of, in front of, behind, next to, adjacent, between, horizontal, vertical, diagonal, longitudinal, transverse, radial, axial, clockwise, counter-clockwise, etc., are used for convenience in referring to such component, apparatus, location, feature, or a portion thereof or movement, force, or other dynamic action in the drawings and are not intended to be limiting.

Furthermore, unless otherwise stated, any specific dimensions mentioned in this description are merely representative of an exemplary implementation of a device embodying aspects of the disclosure and are not intended to be limiting.

The use of the term “about” applies to all numeric values specified herein, whether or not explicitly indicated. This term generally refers to a range of numbers that one of ordinary skill in the art would consider as a reasonable amount of deviation to the recited numeric values (i.e., having the equivalent function or result) in the context of the present disclosure. For example, and not intended to be limiting, this term can be construed as including a deviation of 10 percent of the given numeric value provided such a deviation does not alter the end function or result of the value. Therefore, under some circumstances as would be appreciated by one of ordinary skill in the art a value of about 1% can be construed to be a range from 0.9% to 1.1%.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as well as instances in which the event, circumstance, characteristic, or property occurs to a close approximation, such as accounting for typical tolerance levels or variability of the embodiments described herein.

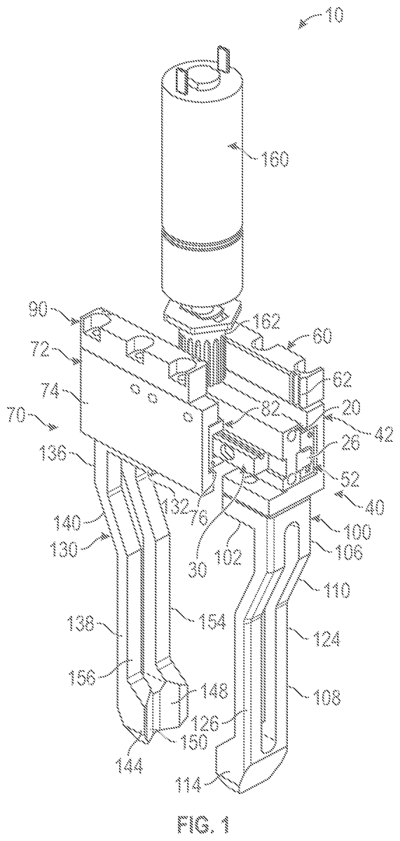

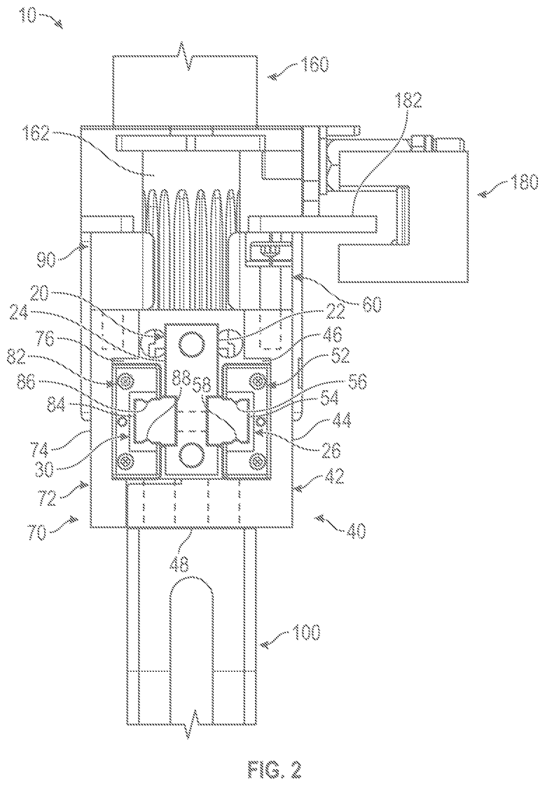

FIG. 1 is a perspective view and FIG. 2 is an end view of an example of an automated mechanism 10 for gripping an item as disclosed herein. In an example, the mechanism may be particularly configured for gripping a longitudinally-elongated item, such as a container, oriented in a vertical, upright manner, such as a test tube, with or without a cap enclosing an open end of the container. Mechanism 10, which may be a robotically-controlled component of a pick-and-place mechanism that provides lateral and vertical motion of the mechanism 10, includes a first gripper finger assembly 40 that includes a first gripper finger 100 and a second gripper finger assembly 70 that includes a second gripper finger 130. The first and second gripper finger assemblies 40, 70 are configured to be movable with respect to each other so as to move the first and second gripper fingers 100, 130 toward or away from each other to selectively grip or release an item with the gripper fingers 100, 130. FIG. 1 shows mechanism 10 in a first, or open, position with the first and second gripper fingers 100, 130 disposed apart from each other. A drive motor 160 is coupled to the first and second gripper finger assemblies 40, 70 such that rotation of the drive motor 160 in a first direction causes the first and second gripper fingers 100, 130 to move toward each other, and rotation of the drive motor 160 in a second direction causes the first and second gripper fingers 100, 130 to move away from each other. Drive motor 160 may be any motor that can be operated in a torque mode or current controlled mode. For example, drive motor 160 may be a DC brush motor or a brushless DC motor. The drive motor may alternatively comprise a stepper motor with the correct electronic drive control.

One or more position sensors may be provided on first gripper finger assembly 40 and/or second gripper finger assembly 70 to monitor the positional status of the gripper finger assembly. Exemplary sensors may include optical sensors, such as sensor 180 shown in FIG. 1, which includes a spaced-apart transmitter and receiver pair that detects positioning of a sensor flag 182 attached to the first gripper finger assembly 40. One or more similar sensors may be associated with second gripper finger assembly 70. Different statuses that may be monitored include gripper mechanism 10 fully open, gripper mechanism 10 fully closed with no container (e.g., test tube) between the gripper fingers 100, 130, or gripper mechanism 10 fully closed with a container between the gripper fingers 100, 130. In addition, the sensors may be configured to detect containers of different sizes between the fully closed gripper fingers 100, 130.

Mechanism 10 includes a linear rail mount 20 having a first side 22 and a second side 24 laterally-opposite the first side 22. The linear rail mount 20 generally bisects the mechanism 10 between first and second sides of the mechanism that may be mirror images of each other.

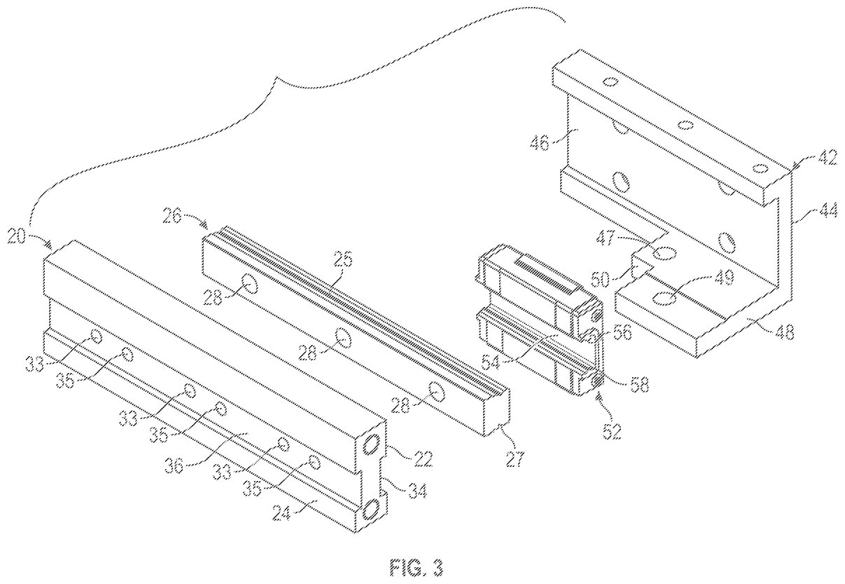

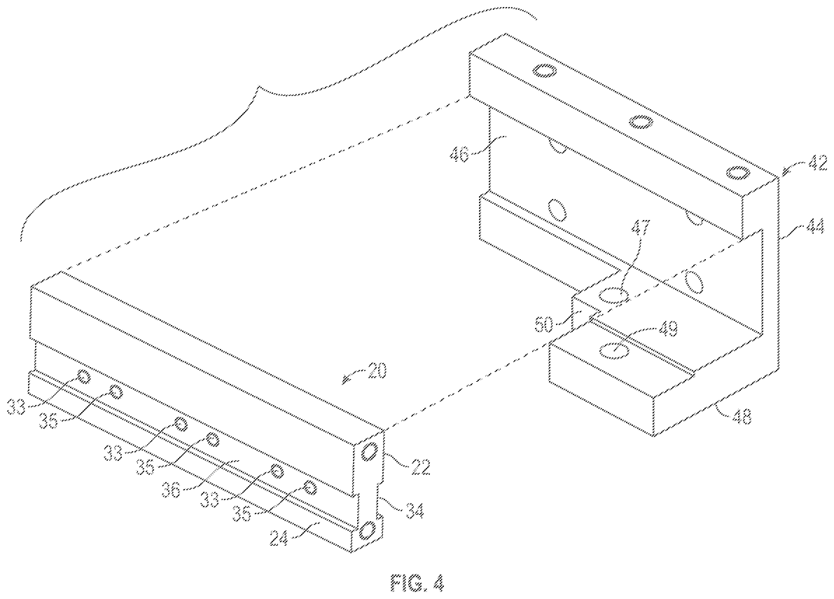

As shown in FIGS. 1, 2, and 3, a first linear rail 26 is disposed on the first side 22 of the linear rail mount 20, and as shown in FIGS. 1, 2 and 5, a second linear rail 30 is disposed on the second side 24 of the linear rail mount 20. In an example, as shown in FIGS. 3-5, linear rail mount 20 includes a first longitudinal groove 34 formed on first side 22 and a second longitudinal groove 36 formed on second side 24. First linear rail 26 may be secured in groove 34 by mechanical fasteners, and second linear rail 30 may be secured in groove 36 by mechanical fasteners. Fastener openings may be formed through each linear rail, such as fastener openings 28 extending through the first linear rail 26 shown in FIG. 3 and fastener openings 32 extending through second linear rail 30 shown in FIGS. 5 and 8. Mechanical fasteners, such as screws, bolts, rivets, etc. (not shown) extend through the fastener openings, such as fastener openings 28 and 32, into fastener-receiving openings formed in the linear rail mount 20, such as fastener-receiving openings 33 and 35 shown in FIG. 3-5. The first linear rail 26 and the second linear rail 30 may be longitudinally offset with respect to each other, for example, by securing the first linear rail 26 to fastener-receiving openings 35 formed in the linear rail mount 20 and securing the second linear rail 30 to fastener-receiving openings 33 also formed in the rail mount 20 and longitudinally offset from the fastener-receiving openings 35.

As shown in FIG. 3, in the illustrated example, first linear rail 26 includes a top groove 25 extending longitudinally along the top of the horizontally-oriented first linear rail 26 and a bottom groove 27 extending longitudinally along the bottom of the horizontally-oriented first linear rail 26. As shown in FIGS. 5 and 8, in the illustrated example, second linear rail 30 includes a top groove 37 extending longitudinally along the top of the horizontally-oriented second linear rail 30 and a bottom groove 38 extending longitudinally along the bottom of the horizontally-oriented second linear rail 30.

With reference to FIGS. 1, 2, and 3, in one example, the first gripper finger assembly 40 includes a first gripper finger mount 42 disposed on the first side 22 of the linear rail mount 20 and a first side linear rail guide 52 disposed between the first finger gripper finger mount 42 and the first side 22 of the linear rail mount 20 and that receives the first linear rail 26. Second gripper finger assembly 70 includes a second gripper finger mount 72 disposed on the second side 24 of the linear rail mount 20 and a second side linear rail guide 82 disposed between the second finger gripper finger mount 72 and the second side 24 of the linear rail mount 20 and that receives the second linear rail 30.

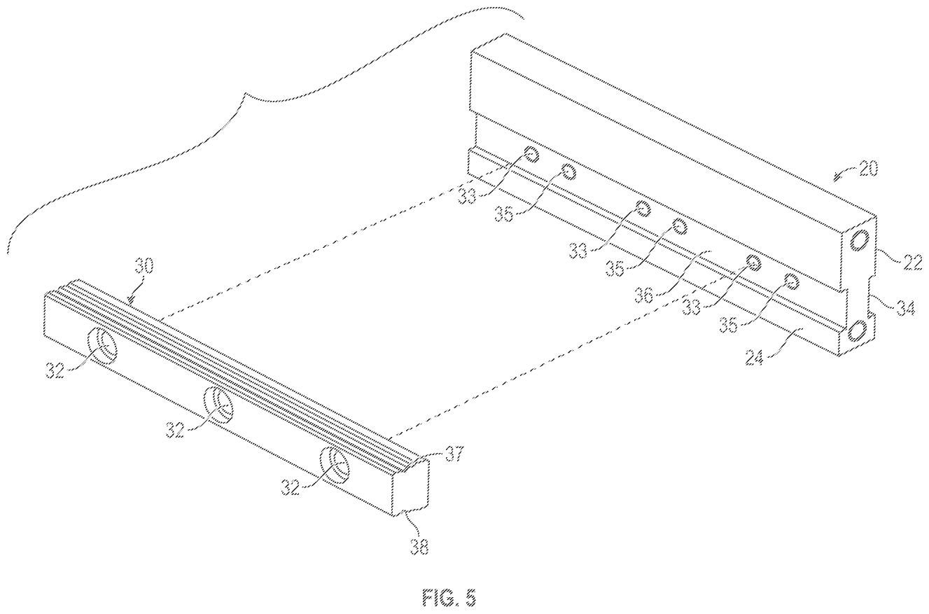

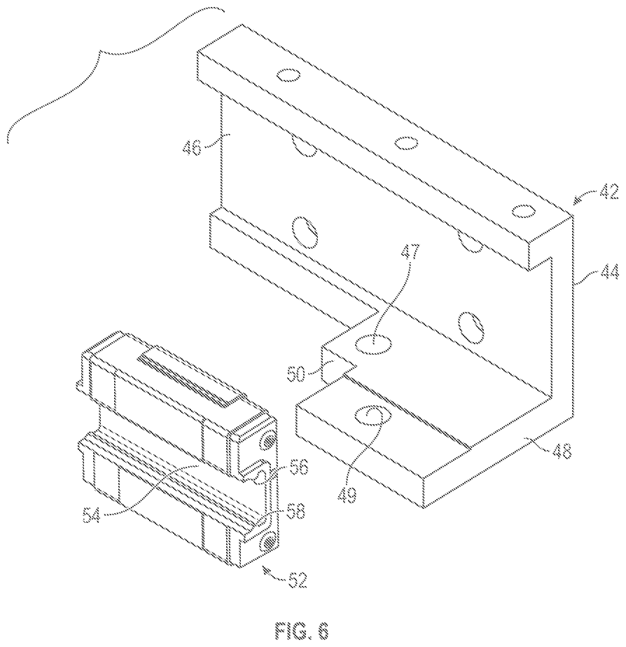

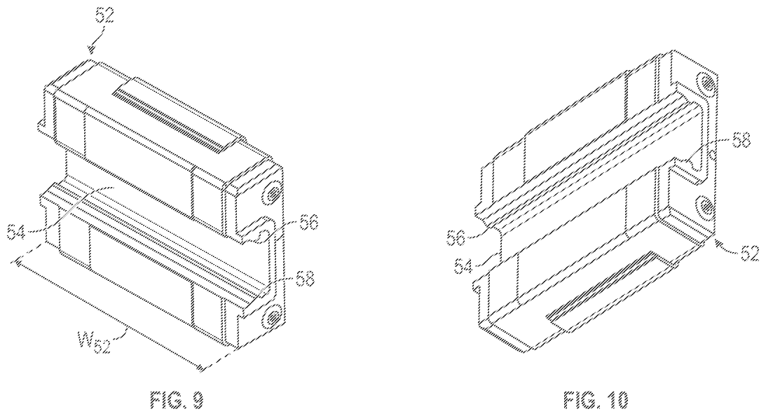

As shown in FIGS. 2, 3, 4, 6, and 7, in one example, the first finger gripper finger mount 42 includes a vertical wall 44 disposed adjacent the first side 22 of the linear rail mount 20, and a first mounting flange 48 of the first finger gripper finger mount 42 extends laterally from a bottom edge of the vertical wall 44 beyond the second side 24 of the linear rail mount 20 (see FIGS. 1 and 2). Similarly, as can be seen in FIGS. 2 and 11, second gripper finger mount 72 includes a vertical wall 74 disposed adjacent the second side 24 of the linear rail mount 20, and a second mounting flange 78 of the second finger gripper finger mount 72 extends laterally from a bottom end of the vertical wall 74 beyond the first side 22 of the linear rail mount 20. In one example, second gripper finger mount 72 is a mirror image duplicate of the first gripper finger mount 42. Features of first side linear rail guide 52 of the first gripper finger assembly 40 are shown in FIGS. 3, 6, 9, and 10. In an embodiment, first gripper finger assembly 40 includes two first side linear rail guides 52 arranged end-to-end to accommodate the full length of the first linear rail 26. Because each of the first side linear rail guides 52 are identical, only one is shown in the drawings and described below.

Each first side linear rail guide 52 is disposed within a rail guide slot 46 formed in the vertical wall 44 of the first finger gripper finger mount 42 and is attached to the first finger gripper mount 42. Each first side linear rail guide 52 includes a rail slot 54 that slidably receives a portion of the first linear rail 26 and may include an upper ridge 56 extending longitudinally along a top side of the rail slot 54 and a lower ridge 58 extending longitudinally along a bottom side of rail slot 54. Upper ridge 56 of first side linear rail guide 52 extends into top groove 25 of first linear rail 26, and lower ridge 58 extends into bottom grove 27 of first linear rail 26. At least the sides of the rail guide slot 54 and upper and lower ridges 56, 58 may be made of low-friction material (e.g., a self-lubricating plastic). Exemplary low-friction materials may include Delrin®, ultra-high-molecular-weight polyethylene (UHMW), Teflon, and Acetal. Alternatively, each first side linear rail guide 52 may comprise linear rows of ball bearings, instead of upper and lower ridges 56, 58, on the upper and lower sides of the rail slot 54 that engage the upper and lower grooves 25 and 27 of the first linear rail 26.

As shown in FIGS. 1 and 2, second side linear rail guide 82 of the second gripper finger assembly 70 is disposed within a rail guide slot 76 formed in the vertical wall 74 of the second gripper finger mount 72. In an embodiment, second gripper finger assembly 70 includes two second side linear rail guides 82 arranged end-to-end to accommodate the full length of the second linear rail 30.

Each second side linear rail guide 82 has a similar configuration as (or is identical to) first side linear rail guide 52 and receives and engages a portion of second linear rail 30 and top and bottom grooves 37, 38 in the same manner that first side linear rail guide 52 receives and engages first linear rail 26 and top and bottom grooves 27, 28. In particular, each second side linear rail guide 82 includes a rail slot 84 that slidably receives the second linear rail 30 and may include an upper ridge 86 (or row of bearings) extending longitudinally along a top side of the rail slot 84 and a lower ridge 88 (or row of bearings) extending longitudinally along a bottom side of rail slot 84. Upper ridge 86 of each second side linear rail guide 82 extends into top groove 37 of second linear rail 30, and lower ridge 88 extends into bottom grove 38 of second linear rail 30. At least the sides of the rail guide slot 84 and upper and lower ridges 86, 88 may be made of low-friction material (e.g., a self-lubricating plastic). Exemplary low-friction materials may include Delrin, ultra-high-molecular-weight polyethylene (UHMW), Teflon, and Acetal.

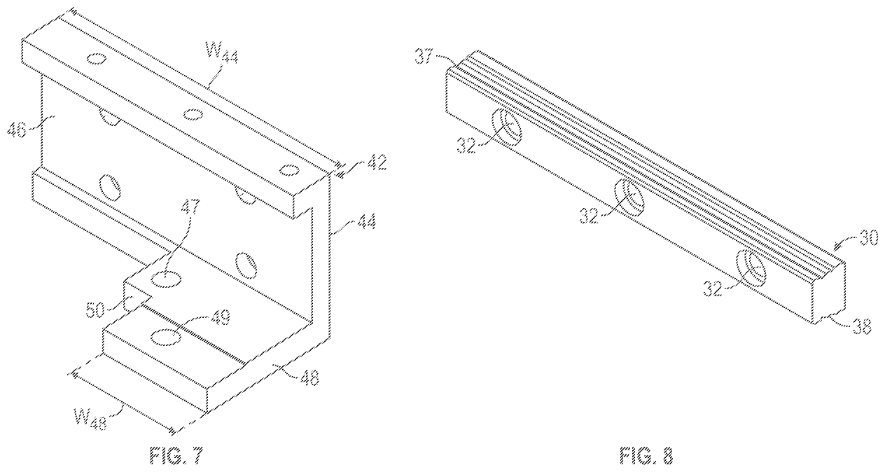

As shown in FIG. 7, the width W₄₄ of the vertical wall 44 of first gripper finger mount 42 is longer than the width W₄₈ of the first mounting flange 48. In an embodiment, width W₄₄ is approximately twice the width W₅₂ of each first side linear rail guide 52. In one example, width W₄₄ is significantly longer, e.g., at least two times longer, than width W₄₈. Similarly, although not labeled in the drawings, the width of the vertical wall 74 of second gripper finger mount 72 is longer than the width of the second mounting flange 78 and is approximately twice the width of each second side linear rail guide 82.

Because first linear rail 26 is secured to the first side 22 of linear rail mount 20, and each first side linear rail guide 52 is mounted to the vertical wall 44 of first gripper finger mount 42, the first gripper finger assembly 40, including first gripper finger mount 42, first side linear rail guides 52, and first gripper finger 100, is supported on a top side of the first linear rail 26. And because second linear rail 30 is secured to the second side 24 of linear rail mount 20, and each second side linear rail guide 82 is mounted to the vertical wall 74 of first gripper finger mount 72, the second gripper finger assembly 70, including second gripper finger mount 72, second side linear rail guides 82, and second gripper finger 130, is supported on a top side of the second linear rail 36.

In an example, to minimize mechanical play between the first and second gripper assemblies 40, 70 and the linear rail mount 20, there is a tight dimensional tolerance (e.g., ±0.015 mm) between the width of the first linear rail 26 and the width of the rail slots 54 of the first side linear rail guides 52 and between the width of the second linear rail 30 and the widths of the rail slots 84 of the second side linear rail guide 82.

Exemplary first and second linear rails 26, 30 are available from THK, model no. SRS 5M rail, precision grade, with light preload (−1 to 0 μm). The linear rail guides 52, 82 may comprise linear bearing rail carriages available from THK, model no. SRS 5M block.

Details of the mounting of the first and second gripper fingers 100, 130 to the first and second gripper finger mounts 42, 72, respectively, are shown in FIG. 11 and details of the first and second gripper fingers 100, 130 are shown in FIGS. 11-17. In an example, first gripper finger 100 is secured to the first mounting flange 48 of the first gripper finger mount 42 and extends below the linear rail mount 20. First gripper finger 100 includes a first mounting base 102 having connector holes 103, 105 formed therein, which are aligned with connector holes 47, 49, respectively, formed in first mounting flange 48 of first gripper finger mount 42 (see FIG. 11) and through which connecters (e.g., screws, bolts, rivets, etc.) (not shown) may be inserted. As shown in FIGS. 13 and 14, in an example, the mounting base 102 of the first gripper finger 100 has a step 104 formed in an edge of the mounting base facing the mounting base of the second gripper finger 130. In the examples shown, connector holes 103, 105 of mounting base 102 are arranged at a diagonal with respect to each other, as opposed to being laterally adjacent to each other, with connector hole 103 formed in the forward, non-stepped portion of the mounting base 102. Similarly, connector holes 47, 49 of first mounting flange 48 are arranged at a diagonal with respect to each other, as opposed to being laterally adjacent to each other, with connector hole 47 formed in the forward, non-stepped portion of the mounting flange 48.

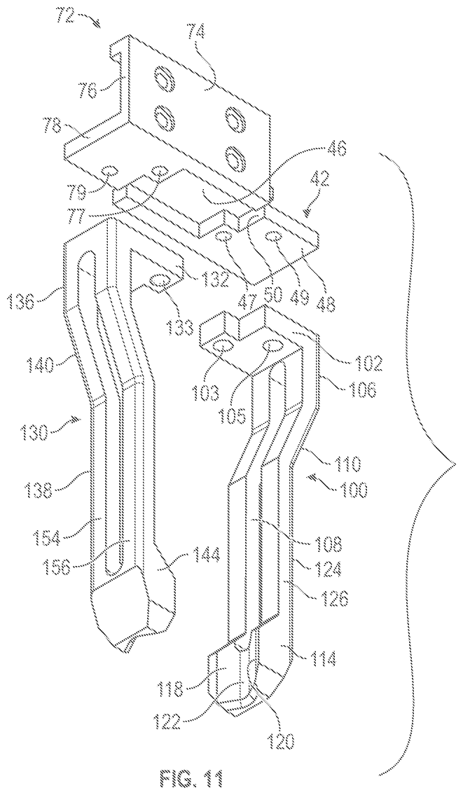

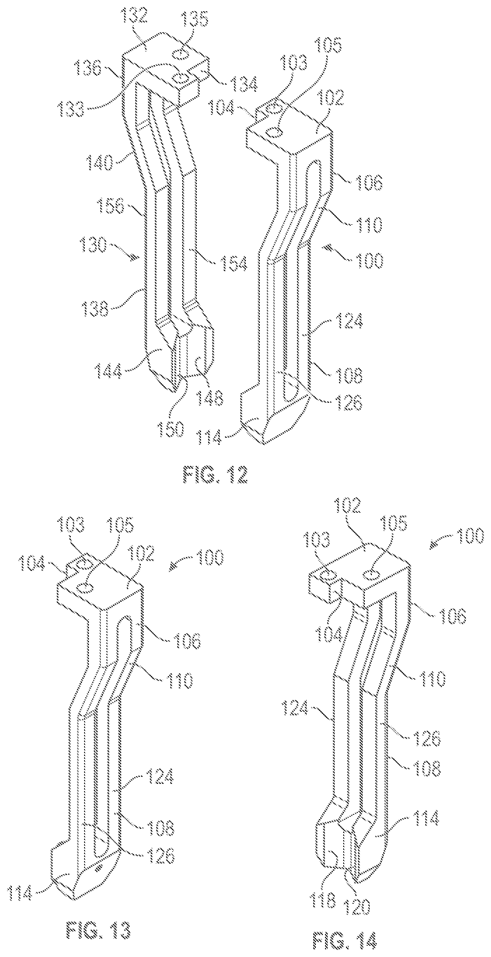

In an example, second gripper finger 130 is secured to the second mounting flange 78 of the second gripper finger mount 72 and extends below the linear rail mount 20. In a further example, second gripper finger 130 includes a first mounting base 132 having connector holes 133, 135 formed therein, which are aligned with connector holes 77, 79, respectively, formed in second mounting flange 78 of second gripper finger mount 72 (see FIG. 11) and through which connecters (e.g., screws, bolts, rivets, etc.) (not shown) may be inserted. As shown in FIG. 12, in an example, the mounting base 132 of the second gripper finger 130 has a step 134 formed in an edge of the mounting base facing the mounting base 102 and step 104 of the first gripper finger 100. In the examples shown, connector holes 133, 135 of mounting base 132 and connector holes 77, 79 of second mounting flange 78 (see FIGS. 11, 12) are arranged at a diagonal with respect to each other, as opposed to being laterally adjacent to each other.

In one example, first gripper finger 100 comprises an upper vertical segment 106, a lower vertical segment 108, and an angled segment 110 between a lower end of the upper vertical segment 106 and an upper end of the lower vertical segment 108. Accordingly, the lower vertical segment 108 is laterally offset by a length 112 to a position closer to the second gripper finger 130 than the upper vertical segment 106 (FIG. 15). Referring to FIGS. 12-14, first gripper finger 100 further includes a gripper segment 114 that is laterally offset by an amount 116 (see FIG. 15) from the lower vertical segment 108 so as to be disposed closer to the second gripper finger 130 than the lower vertical segment 108.

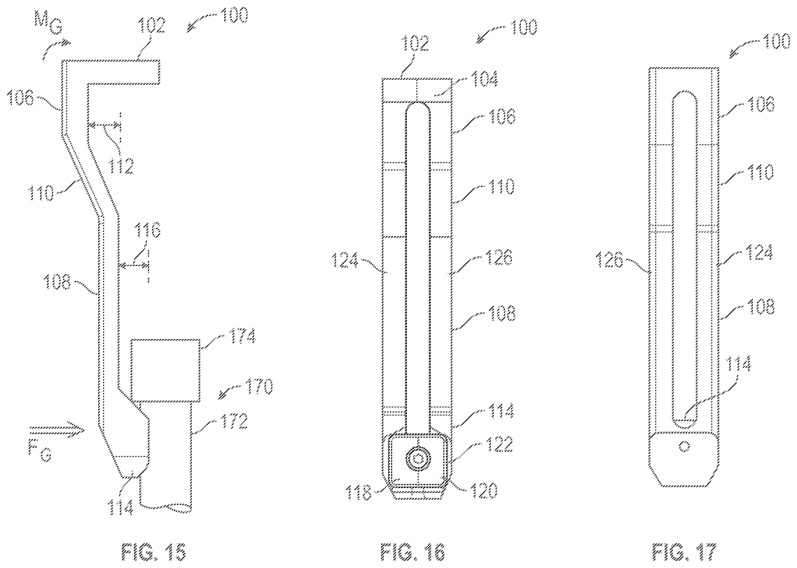

In an example, gripper segment 114 includes converging, angled gripping surfaces 118, 120. As shown in FIG. 16, the gripper segment 114 may also include an elastomeric gripping pad 122 covering the angled gripping surfaces 118, 120. Suitable materials for the gripping pad 122 provide good chemical and wear resistance. An exemplary material for the gripping pad 122 comprises a fluoropolymer elastomer and synthetic rubber compound available from DuPont under the brand name Viton®.

Similarly, second gripper finger 130 comprises an upper vertical segment 136, a lower vertical segment 138, and an angled segment 130 between a lower end of the upper vertical segment 136 and an upper end of the lower vertical segment 138. Accordingly, the lower vertical segment 138 is laterally offset to a position closer to the first gripper finger 100 than the upper vertical segment 136. Second gripper finger 130 further includes a gripper segment 144 that is laterally offset from the lower vertical segment 138 so as to be disposed closer to the first gripper finger 100 than the lower vertical segment 138.

In an example, gripper segment 144 includes converging, angled gripping surfaces 148, 150. Gripper segment 144 may also include an elastomeric gripping pad (not shown) covering the angled gripping surfaces 148, 150.

In an embodiment, the upper vertical segment 106, the lower vertical segment 108, and the angled segment 110 of the first gripper finger 100 comprise spaced-apart bars 124, 126. Similarly, the upper vertical segment 136, the lower vertical segment 138, and the angled segment 140 of the second gripper finger 130 comprise spaced-apart bars 154, 156.

As shown in FIG. 15, the converging, angled gripping surfaces 118, 120 of the first gripper finger 100 enable the gripper finger to grip a tubular body 172 of a container 170. The lateral offset 116 between the gripper segment 114 and the lower vertical segment 108 provides clearance for a cap 174 of the container 170 that is wider than the tubular body 172. When the container is grasped by the mechanism 10, container 170 is grasped between first gripper finger 100 contacting one side of tubular body 172 of the container 170 below the cap 174, as shown in FIG. 15, and second gripper finger 130 contacting an opposite side of tubular body 172 of the container 170 below the cap 174, (although not shown in FIG. 15, second gripper finger 130 would be a mirror image of first gripper finger 100).

As shown in FIG. 1, a first rack 60 having rack teeth 62 is fastened to the first gripper finger mount 42, such as by mechanical fasteners, (e.g., screws, bolts, rivets, etc.) (not shown). In an alternate example, first rack 60 is an integral part of the first gripper finger mount 42. Similarly, a second rack 90 having rack teeth 92 is fastened to the second gripper finger mount 72, such as by mechanical fasteners, (e.g., screws, bolts, rivets, etc.) (not shown). In an alternate example, second rack 90 is an integral part of the second gripper finger mount 72.

A pinion gear 162 is operatively coupled to drive motor 160, for example, by being attached to a drive shaft of drive motor 160. Pinion gear 162 is disposed between first rack 60 and second rack 90, and its teeth are engaged with rack teeth 62 and rack teeth 92. Accordingly, rotation of the pinion gear 162 by drive motor 160 causes rack 60 and first gripper finger mount 42 and first side linear rail guide 52 to slide in a first direction with respect to first linear rail 26 and causes rack 90 and second gripper finger mount 72 and second side linear rail guide 82 to slide in a second, opposite direction with respect to second linear rail 30. Therefore, rotation of the pinion gear 162 by drive motor 160 in a first direction causes the first and second gripper fingers 100, 130 attached to the first and second gripper finger mounts 42, 72, respectively, to move toward each other (e.g., to grip an item, such as tubular body 172 of container 170 (see FIG. 15), and rotation of the pinion gear 162 by drive motor 160 in a second, opposite direction causes the first and second gripper fingers 100, 130 to move away from each other (e.g., to release the item or to move the gripper fingers far enough apart that the mechanism 10 can be lowered and the gripper fingers will clear the cap 174). Sensors mounted to a housing (not shown) are communicatively coupled to the drive motor 160 to instruct the drive motor 160 when to stop moving the first and second gripper fingers 100, 130 toward each other.

A step 50 formed in first mounting flange 48 of first gripper finger mount 42 is aligned with step 104 of first mounting base 102 of first gripper finger 100. Similarly, a step 80 formed in second mounting flange 78 of second gripper finger mount 72 is aligned with step 134 of second mounting base 132 of second gripper finger 130. Furthermore, step 50 and step 104 are a mirror image of step 80 and step 134, respectively. As the first and second gripper fingers 100, 130 are moved toward each other, the steps 50, 104 fit within steps 80, 134, respectively, to allow the first and second gripper fingers 100, 130 to be moved closer together than what would be possible if the mounting flanges 48, 78 and mounting bases 102, 132 were not stepped.

Referring to FIG. 15, when the first gripper finger 100 is closed to grip an item—such as container 170—the gripping force F_{G} applied at gripper segment 114 generates a counter-acting twisting moment M_{G} at the first mounting base 102. Similarly, when the second gripper finger 130 is closed to grip an item—such as container 170—the gripping force F applied at gripper segment 144 generates a counter-acting twisting moment M at the second mounting base 132 in opposite directions to F_{G} and M_{G} (not illustrated). The configuration of the gripper fingers 100, 130 and the manner of mounting each gripper finger 100, 130 to its respective gripper finger mount 42, 72 are designed to minimize the amount of deflection of each gripper finger 100, 130 due to the gripping force F_{G} and the resulting twisting moment M_{G}.

First, the angled segments 110 and 140 of the first and second gripper fingers 100, 130, respectively, provide lateral stiffness to each gripper finger (in a fore and aft direction with respect to the directions of movement of the gripper fingers 100, 130) to limit lateral, fore and aft deflection of the first gripper finger between the gripper segment 114 and the first mounting base 102 and of the second gripper finger between the gripper segment 144 and the second mounting base 130 due to the gripping forces F_{G}.

Second, the longitudinal length of mounting base 102 of first gripper finger 100 in the direction parallel to the direction of the gripping force F_{G}, the diagonal arrangement of the connector holes 103, 105 and 47, 50, and the forward positioning of the connector holes 103 and 47 in the non-stepped portions of the first mounting base 102 and first mounting flange 48, respectively, counteract the twisting moment M_{G} with limited or no twisting deflection of the first gripper finger 100 at the first mounting base 102. The mounting of the second gripper finger 130 similarly counteracts the twisting moment M_{G} with limited or no twisting deflection of the second gripper finger 100 at the second mounting base 132. The stepped configurations of the first and second mounting flanges 48, 78 and the first and second mounting bases 102, 132 provide longitudinally long mounting surfaces that counteract the twisting moments M_{G} while also allowing the first and second gripper finger assemblies 40, 70 to move the respective gripper segments 114, 144 into close proximity to one another.

Furthermore, the relatively long width W₄₄ of the vertical wall 44 of the first gripper finger mount 42 supporting the relatively long widths W₅₂ of two first side linear rail guides 52, compared to the width W₄₈ of the first mounting flange 48, provides a long engagement contact between the first side linear rail guides 52 and the first linear rail 26 to counteract the twisting moment M_{G} while minimizing twisting of the first gripper finger assembly 40. Similarly, the relatively long width of the vertical wall 74 of the second gripper finger mount 72 supporting the relatively long widths of two second side linear rail guides 82, compared to the width of the second mounting flange 78, provides a long engagement contact between the second side linear rail guides 82 and the second linear rail 30 to counteract the twisting moment M_{G} while minimizing twisting of the second gripper finger assembly 70.

### Exemplary Embodiments

Aspects of the disclosure are summarized by the following numbered embodiments.

Embodiment 1. A mechanism for gripping a container, the mechanism comprising:
a linear rail mount having first and second, laterally-opposed sides;
first and second linear rails disposed on, respectively, the first and second sides of the linear rail mount;
a first gripper finger mount including a first mounting flange disposed below the linear rail mount;
a first linear rail guide supported on the first gripper finger mount and coupled with the first linear rail on the first side of the linear rail mount;
a first rack supported on the first gripper finger mount;
a second gripper finger mount including a second mounting flange disposed below the linear rail mount;
a second linear rail guide supported on the second gripper finger mount and coupled with the second linear rail on the second side of the linear rail mount;
a second rack supported on the second gripper finger mount;
a first gripper finger secured to the first mounting flange of the first gripper finger mount and extending below the linear rail mount;
a second gripper finger secured to the second mounting flange of the second gripper finger mount and extending below the linear rail mount;
a drive motor; and
a pinion gear coupled to the drive motor and engaged with the first and second racks such that rotation of the pinion gear by the drive motor in a first direction causes the first and second gripper fingers to move toward each other and rotation of the pinion gear by the drive motor in a second direction causes the first and second gripper fingers to move away from each other.

Embodiment 2. The mechanism of embodiment 1, wherein the first linear rail guide of the first gripper finger mount comprises a rail slot that receives the first linear rail, and the second linear rail guide of the second gripper finger mount comprises a rail slot that receives the second linear rail.

Embodiment 3. The mechanism of embodiment 1 or 2, wherein the first and second linear rails are attached to, respectively, the first and second sides of the linear rail mount by mechanical fasteners.

Embodiment 4. The mechanism of any one of embodiments 1 to 3, wherein the first gripper finger mount includes a vertical wall disposed adjacent the first side of the linear rail mount and wherein the first mounting flange of the first gripper finger mount extends laterally from a bottom end of the vertical wall of the first gripper finger mount beyond the second side of the linear rail mount, and the second gripper finger mount includes a vertical wall disposed adjacent the second side of the linear rail mount and wherein the second mounting flange of the second gripper finger mount extends laterally from a bottom end of the vertical wall of the second gripper finger mount beyond the first side of the linear rail mount.

Embodiment 5. The mechanism of embodiment 4, wherein the first linear rail guide of the first gripper finger mount is secured within a slot formed in the vertical wall of the first gripper finger mount, and the second linear rail guide of the second gripper finger mount is secured within a slot formed in the vertical wall of the second gripper finger mount.

Embodiment 6. The mechanism of any one of embodiments 1 to 5, wherein the mounting flange of each of the first and second gripper finger mounts has a step formed in an edge of the mounting flange facing the mounting flange of the other of the first and second gripper finger mounts.

Embodiment 7. The mechanism of embodiment 4 or 6, wherein the first rack is fastened to a top edge of the vertical wall of the first gripper finger mount, and the second rack is fastened to a top edge of the vertical wall of the second gripper finger mount.

Embodiment 8. The mechanism of any one of embodiments 1 to 6, wherein the first rack is fastened to the first gripper finger mount, and the second rack is fastened to the second gripper finger mount.

Embodiment 9. The mechanism of any one of embodiments 1 to 8, wherein the first gripper finger comprises a first mounting base connected to the first mounting flange of the first gripper finger mount, and the second gripper finger comprises a second mounting base connected to the second mounting flange of the second gripper finger mount.

Embodiment 10. The mechanism of embodiment 9, wherein the mounting base of each of the first and second gripper fingers has a step formed in an edge of the mounting base facing the mounting base of the other of the first and second gripper fingers.

Embodiment 11. The mechanism of any one of embodiments 1 to 10, wherein the first gripper finger comprises: an upper vertical segment; a lower vertical segment; an angled segment between a lower end of the upper vertical segment and an upper end of the lower vertical segment so that the lower vertical segment is laterally offset to a position closer to the second gripper finger than the upper vertical segment; and a gripper segment that is laterally offset from the lower vertical segment so as to be disposed closer to the second gripper finger than the lower vertical segment of the first gripper finger, and wherein the second gripper finger comprises: an upper vertical segment; a lower vertical segment; an angled segment between a lower end of the upper vertical segment and an upper end of the lower vertical segment so that the lower vertical segment is laterally offset to a position closer to the first gripper finger than the upper vertical segment; and a gripper segment that is laterally offset from the lower vertical segment so as to be disposed closer to the first gripper finger than the lower vertical segment of the second gripper finger.

Embodiment 12. The mechanism of embodiment 11, wherein the upper vertical segments, the lower vertical segments, and the angled segments comprise spaced-apart bars.

Embodiment 13. The mechanism of embodiment 11 or 12, wherein the gripper segment of each of the first and second gripping fingers comprises converging, angled gripping surfaces.

Embodiment 14. The mechanism of embodiment 13, further comprising an elastomeric gripping pad secured to the angled gripping surfaces of each of the first and second gripping fingers.

Embodiment 15. The mechanism of embodiment 14, wherein the elastomeric gripping pad comprises a fluoropolymer elastomer and synthetic rubber compound.

Embodiment 16. The mechanism of any one of embodiments 1 to 15, wherein the rack of the first gripper finger mount is positioned outwardly from the first side of the linear rail mount and above a top edge of the linear rail mount, and wherein the rack of the second gripper finger mount is positioned outwardly from the second side of the linear rail mount and above a top edge of the linear rail mount.

Embodiment 17. The mechanism of any one of embodiments 1 to 16, wherein the first and second gripping fingers are configured to grasp a container in an upright orientation from a position above the container.

Embodiment 18. The mechanism of any one of embodiments 1 to 17, wherein the container comprises a test tube.

Embodiment 19. A mechanism for gripping a container; the mechanism comprising:
a linear rail mount having first and second, laterally opposed sides;
first and second linear rails disposed on, respectively, the first and second sides of the linear rail mount;
a first gripper finger assembly including first gripper finger and a first gripper finger mount, wherein the first gripper finger mount includes a first linear rail guide coupled with the first linear rail on the first side of the linear rail mount and a first mounting flange disposed below the linear rail mount to which the first gripper finger is attached;
a second gripper finger assembly including a second gripper finger and a second gripper finger mount, wherein the second finger gripper mount includes a second linear rail guide coupled with the second linear rail on the second side of the linear rail mount and second a mounting flange disposed below the linear rail mount to which the second gripper finger is attached, wherein the first and second gripper finger assemblies are configured to be movable with respect to each other so as to move the first and second gripper fingers toward or away from each other; and
a drive motor coupled to the first and second gripper finger assemblies such that rotation of the drive motor in a first direction causes the first and second gripper fingers to move toward each other and rotation of the drive motor in a second direction causes the first and second gripper fingers to move away from each other,
wherein the first gripper finger comprises: an upper vertical segment; a lower vertical segment; an angled segment between a lower end of the upper vertical segment and an upper end of the lower vertical segment so that the lower vertical segment is laterally offset to a position closer to the second gripper finger than the upper vertical segment; and a gripper segment that is laterally offset from the lower vertical segment so as to be disposed closer to the second gripper finger than the lower vertical segment of the first gripper finger, and
wherein the second gripper finger comprises: an upper vertical segment; a lower vertical segment; an angled segment between a lower end of the upper vertical segment and an upper end of the lower vertical segment so that the lower vertical segment is laterally offset to a position closer to the first gripper finger than the upper vertical segment; and a gripper segment that is laterally offset from the lower vertical segment so as to be disposed closer to the first gripper finger than the lower vertical segment of the second gripper finger.

Embodiment 20. The mechanism of embodiment 19, wherein the first gripper finger assembly comprises a first rack and the second gripper finger assembly comprise a second rack, and wherein the mechanism further comprises a pinion gear coupled to the drive motor and operatively engaged with the first and second racks.

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the scope of the following appended claims.

1. A mechanism for gripping a container, the mechanism comprising:
a linear rail mount having first and second, laterally-opposed sides;
first and second linear rails disposed on, respectively, the first and second sides of the linear rail mount;
a first gripper finger mount including a first mounting flange disposed below the linear rail mount;
a first linear rail guide supported on the first gripper finger mount and coupled with the first linear rail on the first side of the linear rail mount;
a first rack supported on the first gripper finger mount;
a second gripper finger mount including a second mounting flange disposed below the linear rail mount;
a second linear rail guide supported on the second gripper finger mount and coupled with the second linear rail on the second side of the linear rail mount;
a second rack supported on the second gripper finger mount;
a first gripper finger secured to the first mounting flange of the first gripper finger mount and extending below the linear rail mount;
a second gripper finger secured to the second mounting flange of the second gripper finger mount and extending below the linear rail mount;
a drive motor; and
a pinion gear coupled to the drive motor and engaged with the first and second racks such that rotation of the pinion gear by the drive motor in a first direction causes the first and second gripper fingers to move toward each other and rotation of the pinion gear by the drive motor in a second direction causes the first and second gripper fingers to move away from each other.

2. The mechanism of claim 1, wherein the first linear rail guide of the first gripper finger mount comprises a rail slot that receives the first linear rail, and the second linear rail guide of the second gripper finger mount comprises a rail slot that receives the second linear rail.

3. The mechanism of claim 1, wherein the first and second linear rails are attached to, respectively, the first and second sides of the linear rail mount by mechanical fasteners.

4. The mechanism of claim 1, wherein the first gripper finger mount includes a vertical wall disposed adjacent the first side of the linear rail mount and wherein the first mounting flange of the first gripper finger mount extends laterally from a bottom end of the vertical wall of the first gripper finger mount beyond the second side of the linear rail mount, and the second gripper finger mount includes a vertical wall disposed adjacent the second side of the linear rail mount and wherein the second mounting flange of the second gripper finger mount extends laterally from a bottom end of the vertical wall of the second gripper finger mount beyond the first side of the linear rail mount.

5. The mechanism of claim 4, wherein the first linear rail guide of the first gripper finger mount is secured within a slot formed in the vertical wall of the first gripper finger mount, and the second linear rail guide of the second gripper finger mount is secured within a slot formed in the vertical wall of the second gripper finger mount.

6. The mechanism of claim 1, wherein the mounting flange of each of the first and second gripper finger mounts has a step formed in an edge of the mounting flange facing the mounting flange of the other of the first and second gripper finger mounts.

7. The mechanism of claim 4, wherein the first rack is fastened to a top edge of the vertical wall of the first gripper finger mount, and the second rack is fastened to a top edge of the vertical wall of the second gripper finger mount.

8. The mechanism of claim 1, wherein the first rack is fastened to the first gripper finger mount, and the second rack is fastened to the second gripper finger mount.

9. The mechanism of claim 1, wherein the first gripper finger comprises a first mounting base connected to the first mounting flange of the first gripper finger mount, and the second gripper finger comprises a second mounting base connected to the second mounting flange of the second gripper finger mount.

10. The mechanism of claim 9, wherein the mounting base of each of the first and second gripper fingers has a step formed in an edge of the mounting base facing the mounting base of the other of the first and second gripper fingers.

11. The mechanism of claim 1, wherein the first gripper finger comprises:
an upper vertical segment;
a lower vertical segment;
an angled segment between a lower end of the upper vertical segment and an upper end of the lower vertical segment so that the lower vertical segment is laterally offset to a position closer to the second gripper finger than the upper vertical segment; and
a gripper segment that is laterally offset from the lower vertical segment so as to be disposed closer to the second gripper finger than the lower vertical segment of the first gripper finger, and wherein the second gripper finger comprises:
an upper vertical segment;
a lower vertical segment;
an angled segment between a lower end of the upper vertical segment and an upper end of the lower vertical segment so that the lower vertical segment is laterally offset to a position closer to the first gripper finger than the upper vertical segment; and
a gripper segment that is laterally offset from the lower vertical segment so as to be disposed closer to the first gripper finger than the lower vertical segment of the second gripper finger.

12. The mechanism of claim 11, wherein the upper vertical segments, the lower vertical segments, and the angled segments comprise spaced-apart bars.

13. The mechanism of claim 11, wherein the gripper segment of each of the first and second gripping fingers comprises converging, angled gripping surfaces.

14. The mechanism of claim 13, further comprising an elastomeric gripping pad secured to the angled gripping surfaces of each of the first and second gripping fingers.

15. The mechanism of claim 14, wherein the elastomeric gripping pad comprises a fluoropolymer elastomer and synthetic rubber compound.

16. The mechanism of claim 1, wherein the rack of the first gripper finger mount is positioned outwardly from the first side of the linear rail mount and above a top edge of the linear rail mount, and wherein the rack of the second gripper finger mount is positioned outwardly from the second side of the linear rail mount and above a top edge of the linear rail mount.

17. The mechanism of claim 1, wherein the first and second gripping fingers are configured to grasp a container in an upright orientation from a position above the container.

18. The mechanism of claim 1, wherein the container comprises a test tube.

19. A mechanism for gripping a container; the mechanism comprising:
a linear rail mount having first and second, laterally opposed sides;
first and second linear rails disposed on, respectively, the first and second sides of the linear rail mount;
a first gripper finger assembly including first gripper finger and a first gripper finger mount, wherein the first gripper finger mount includes a first linear rail guide coupled with the first linear rail on the first side of the linear rail mount and a first mounting flange disposed below the linear rail mount to which the first gripper finger is attached;
a second gripper finger assembly including a second gripper finger and a second gripper finger mount, wherein the second finger gripper mount includes a second linear rail guide coupled with the second linear rail on the second side of the linear rail mount and second a mounting flange disposed below the linear rail mount to which the second gripper finger is attached, wherein the first and second gripper finger assemblies are configured to be movable with respect to each other so as to move the first and second gripper fingers toward or away from each other; and
a drive motor coupled to the first and second gripper finger assemblies such that rotation of the drive motor in a first direction causes the first and second gripper fingers to move toward each other and rotation of the drive motor in a second direction causes the first and second gripper fingers to move away from each other,
wherein the first gripper finger comprises:
an upper vertical segment;
a lower vertical segment;
an angled segment between a lower end of the upper vertical segment and an upper end of the lower vertical segment so that the lower vertical segment is laterally offset to a position closer to the second gripper finger than the upper vertical segment; and
a gripper segment that is laterally offset from the lower vertical segment so as to be disposed closer to the second gripper finger than the lower vertical segment of the first gripper finger, and
wherein the second gripper finger comprises:
an upper vertical segment;
a lower vertical segment;
an angled segment between a lower end of the upper vertical segment and an upper end of the lower vertical segment so that the lower vertical segment is laterally offset to a position closer to the first gripper finger than the upper vertical segment; and
a gripper segment that is laterally offset from the lower vertical segment so as to be disposed closer to the first gripper finger than the lower vertical segment of the second gripper finger.

20. The mechanism of claim 19, wherein the first gripper finger assembly comprises a first rack and the second gripper finger assembly comprise a second rack, and wherein the mechanism further comprises a pinion gear coupled to the drive motor and operatively engaged with the first and second racks.
